(19) United States
(12) Patent Application Publication
(10) Pub. No.: US 2023/0337593 A1
(43) Pub. Date: Oct. 26, 2023

(54) AUTONOMOUS GREENHOUSE

(71) Applicant: Canopii Inc., Portland, OR (US)

(72) Inventors: David Lawrence Ashton, Portland, OR (US); Justin Vernon Gravett, Portland, OR (US)

(21) Appl. No.: 17/938,212

(22) Filed: Oct. 5, 2022

Related U.S. Application Data
(60) Provisional application No. 63/363,467, filed on Apr. 22, 2022.
(60) Provisional application No. 63/363,474, filed on Apr. 22, 2022.

(51) Int. Cl. A01G 9/14; B25J 15/08; A01G 9/26

(52) U.S. Cl. CPC A01G 9/14; A01G 9/26; B25J 15/08

(57) ABSTRACT

Techniques and systems are used to operate a fully automated vertical greenhouse for low-cost and sustainable production of local produce. The system includes robotic configurations that seed, propagate, transplant, water, and harvest plants, such as leafy greens and herbs, autonomously without direct human intervention. The system may manage and control a process for sprouting seeds, which is the beginning of a plant life cycle and is initiated by first watering. The system may manage and control a process for moving plants from sprouting growing conditions to adult growing conditions, which further include delivery of nutrient rich water to the adult plants. The system may also manage and control a process for gathering and sorting of mature plants (e.g., crops), which may be automatically prepared and sorted for delivery to retail locations.

### CROSS-REFERENCE TO RELATED APPLICATIONS

This application claims priority and benefit from the U.S. Provisional Pat. Application 63/363,467, filed Apr. 21, 2022, and titled, “SYSTEMS AND METHODS FOR ROBOTIC FARMING” and U.S. Provisional Patent Application 63/363,474, filed Apr. 21, 2022, and titled, “SYSTEMS AND METHODS FOR ROBOTIC FARMING”, which are incorporated herein by reference in their entirety for all purposes.

### BACKGROUND

Greenhouses provide controlled and protective environments for growing many types of plants, as well as eliminating some of the unpredictability of farming in open fields. For example, temperature and light may be controlled to provide an ideal “climate” for particular types of plants. Such indoor growing also allows for seasonal products to be grown year-round because pests and seasonal weather, for example, are factors that are mostly eliminated. In particular, greenhouses allow for a substantial amount of control of growing conditions and time of harvest for plants destined for food production. A greenhouse environment is also well-suited for growing plants hydroponically (e.g., without soil) while also prioritizing cleanliness, so as to allow for ready-to-eat produce that need not be washed by a consumer.

While providing benefits, greenhouses also have a number of problems. For example, ventilation, heating, and cooling are generally required at various times during plant growth to maintain desired temperatures. Thus, operating costs for creating and maintaining a suitable environment within a greenhouse can be both energy inefficient and prohibitively expensive. Another problem is that light filtered through surfaces of a greenhouse may not be provided uniformly to all areas of the greenhouse. In such an environment, plants sitting stationary in one area of the greenhouse may receive adequate lighting while plants sitting stationary in another area may receive inadequate lighting. Yet another problem is that plant diseases can overtake a greenhouse quickly. This problem is exacerbated for monocrops and human interaction inside the greenhouse. A solution to this problem may involve the application of various disinfectants, herbicides, pesticides, fungicides, and/or growth regulators to plants growing within the greenhouse. Human exposure to these chemicals should be generally limited, and protective gear is often required to be worn during application of such chemicals. Aside from health concerns, such chemicals may be expensive and, generally, consumers prefer that these chemicals are not added to plants when possible.

Still other problems with greenhouses are their relatively large footprint, potentially high labor costs, high dependency on supply chains, and their locations, which are often remote from consumers. Benefits, however, mostly outweigh such problems and greenhouses are commonly used. Nevertheless, work continues for finding ways to improve greenhouses by addressing the above-mentioned problems.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a perspective view of a greenhouse enclosure, according to some embodiments.

FIG. 2 is a front view of a greenhouse enclosure, according to some embodiments.

FIG. 3 is a flow diagram of a process for planting, growing, and harvesting, according to some embodiments.

FIG. 4 is a perspective view of a transplanting end effector engaging with growth media in a plant cup that is seated in a plant bed, according to some embodiments.

FIG. 5 is a perspective view of a transplanting end effector engaging with growth media in a plant cup, according to other embodiments.

FIG. 6 is a perspective view of a plant bed carousel system, according to some embodiments.

FIG. 7 is a perspective view of a plant bed, according to some embodiments.

FIG. 8 is a cross-section view of a plant bed, according to some embodiments.

FIG. 9 is a perspective view of a plant cup seated in a plant bed, according to some embodiments.

FIG. 10 is a perspective view of a plant cup, according to some embodiments.

FIG. 11 is a top-front view of a plant cup, according to some embodiments.

FIG. 12 is a perspective view of end effector fingers engaged with a closed plant cup and a post-harvest subsystem, according to some embodiments.

FIG. 13 is a perspective view of a plant in a plant cup engaged with a post-harvest subsystem, according to some embodiments.

FIG. 14 is a perspective view of end effector fingers engaged with a closed plant cup, according to some embodiments.

FIG. 15 is a perspective view of end effector fingers engaged with an opened plant cup, according to some embodiments.

FIG. 16 is a perspective view of a cutting mechanism and plant brackets of a post-harvest subsystem, according to some embodiments.

FIG. 17 includes a series of photographs of plant cups having various features, according to some embodiments.

### DETAILED DESCRIPTION

This disclosure describes methods of operation and a system of a fully automated vertical greenhouse for low-cost and sustainable production of local produce. The system includes robotic configurations that seed, propagate, transplant, water, and harvest plants, such as leafy greens and herbs, autonomously without direct and/or continuous human intervention. For example, the system may manage and control a process for sprouting seeds, which is the beginning of a plant life cycle and is initiated by first watering. The system may manage and control a process for moving plants from sprouting growing conditions to adult growing conditions, which further include delivery of nutrient rich water to the adult plants. The system may also manage and control a process for gathering and sorting of mature plants (e.g., crops), which may be automatically prepared and sorted for delivery to retail locations.

In some embodiments, the system includes control software that manages, controls, and records many if not all aspects of planting, growing, and harvesting plants. For example, such control software may control transportation and positioning of plants within the greenhouse, lighting, temperature, humidity, and harvesting, just to name a few examples. In particular, such control software may manage the complete growing cycles of one or more species of plants.

In some embodiments, the system includes a greenhouse enclosure, germination subsystem, transplanting subsystem, plant suspension and drive subsystem, plant harvester subsystem, post-harvest subsystem, control subsystem, and nutrient delivery subsystem. The greenhouse enclosure provides a controlled environment and support for infrastructure of the system. The germination subsystem automatically plants seeds in a growth medium and waters them while they are transported across a seed propagation conveyor. The seeds and growth media are provided with relatively high intensity artificial light to maximize growth rate. Such artificial light may also be controlled to judiciously and purposely deprive the seeds and growth media. Such deprivation may be used, after plant watering for example, to help with growth uniformity of the sprouts. After sprouting, the new plants, or growth medium without a sprout, may be inspected by a computer vision system. Non-sprouted seeds may be discarded, for example. The transplanting subsystem includes a transplanting robot that distributes healthy sprouts from the germination subsystem to the plant suspension and drive subsystem. The plant suspension and drive subsystem suspends and circulates plants through various parts of the greenhouse enclosure to provide the plants with substantially even light exposure. The plant suspension and drive subsystem is also configured to transport plants from the transplanting operation and to a harvesting location. The plant harvester subsystem is configured to harvest plants by transporting them to the post-harvest subsystem, where plant roots are removed, and plants are sorted into bins for distribution. The post-harvest subsystem may also be configured to inspect each harvested plant, using computer vision for quality and consistency, and to clean plant cups for reuse.

The control subsystem controls, among other things, climate, water nutrient dosing, and robotics of the various subsystems. The control subsystem may also be configured to collect crop, weather, and security data to provide system analysis. The nutrient delivery subsystem is configured to deliver nutrient-rich water to plants using a modified ebb and flow approach, which is a hydroponic technique involving frequent filling and draining of plant beds with water having all the dissolved nutrients required for plant growth. The nutrient-rich water fills plant beds and is drained once the nutrients are depleted. The water may be re-circulated past the bare roots of plants in a channel. In other embodiments, the nutrient delivery subsystem is configured to deliver the nutrient-rich water to plants using a modified nutrient film technique (NFT), which is a hydroponic technique involving a shallow stream of water that contains substantially all the dissolved nutrients required for plant growth. The water may be re-circulated past the bare roots of plants in a channel.

The fully automated vertical greenhouse system provides a number of benefits. For example, the greenhouse system may have a relatively small footprint so as to be easily placed in urban areas and closer to consumers, such as near shopping centers or food store parking lots. In addition, despite the relatively small footprint (e.g., 1200 square feet), a single greenhouse may grow the equivalent of about two acres of an outdoor conventional farm. In some implementations, a fully automated vertical greenhouse as described herein may produce 250 plants per day, for example.

The greenhouse system is fully automated so that human interaction need not occur for weeks or months at a time. The greenhouse system, for example, automatically transports plants to robots for seeding, transplanting, watering, harvesting, removing roots, and sorting. Moreover, the ability of the greenhouse system to maintain a high degree of cleanliness by self-cleaning during various parts of the plant growing process, can allow for longer periods of autonomy, wherein humans need not interact or enter into the growing area of the greenhouse. Such autonomy can help to prevent disease transfer to the plants.

In some embodiments, the plant suspension system may be tied into the frame of the greenhouse. This provides a benefit of allowing for relatively few structural components, thus reducing the cost of the farm. In other words, the greenhouse structure and the plant suspension structure may be combined into one system. In addition, the robotic gantries may also be suspended by the greenhouse frame.

The greenhouse system uses natural sunlight in upper parts of the greenhouse and artificial lights, such as from LEDs, in lower parts of the greenhouse that may otherwise receive little to no natural sunlight. Plant beds, which hold a plurality of plants, are rotated in a carousel fashion to various parts of the greenhouse to provide the plants with both types of light. The amount of light provided to the plants in any part of the greenhouse may be controlled by, for example, using LEDs to supplement natural sunlight.

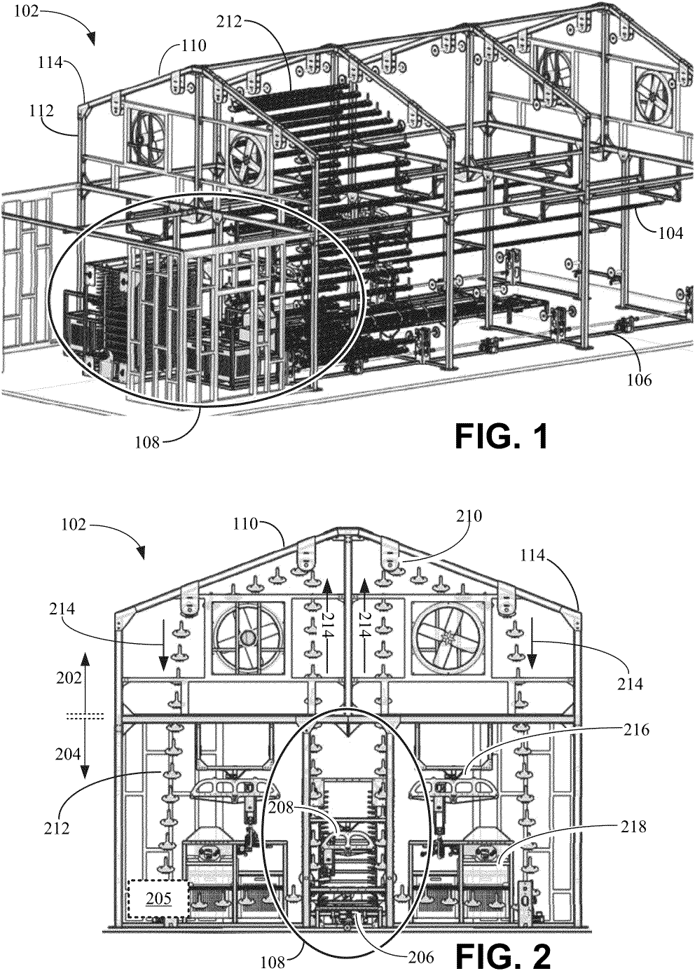

FIG. 1 is a perspective view of a greenhouse enclosure 102 and FIG. 2 is a front view of the greenhouse enclosure, according to some embodiments. Greenhouse enclosure 102 provides a controlled environment and shell that encloses components and plants and supports a framework of plant suspension systems 104 and drive systems 106, for example. In these views, a number of features are not shown. For example, the greenhouse enclosure may include any number of plant growth carousels, though only one is illustrated in the figures.

Greenhouse enclosure 102 provides a number of advantages compared to open-field farming and other types of greenhouse enclosures. For example, in a number of implementations, a front access port in region 108 of greenhouse enclosure 102 allows for relatively quick sub-assembly replacement, if needed, to help ensure that production interruptions are minimal. Greenhouse enclosure 102 may be relatively compact (e.g., 20 feet by 50 feet, a quarter of the size of a basketball court, or other various sizes) so as to fit in small areas such as backyards, campuses, and parking lots, for example. Greenhouse enclosure 102 and its associated systems may include an off-the-shelf programmable climate control system, may use relatively little water via a modified NFT or ebb and flow system, and may use an off-the-shelf programmable nutrient injection system.

Greenhouse enclosure 102 may include at least a partially clear (e.g., polycarbonate) roof 110 and upper walls 112 to allow natural light to enter and shine on plant beds that are in upper portions 202 of the greenhouse enclosure. Sprouts and plants in plant beds that are in lower portions 204 of the greenhouse enclosure may receive supplemental (e.g., artificial) lighting. Greenhouse enclosure 102 may include roll-up doors (not illustrated) on front and back ends to allow for relative ease of workflow. Greenhouse enclosure 102 may include de-constructible framework members 114 that allow the greenhouse enclosure to be broken down for relocation, for example.

Greenhouse enclosure 102 may include a control system 205 configured to operate a germination subsystem 206 that waters seeds in growth media and moves them across a seed propagation conveyor where they will sprout. Relatively high-intensity artificial lights, such as LEDs, may be used to maximize growth rate. Germination subsystem 206 may include an in-process inspection system that uses computer vision to inspect the young plants. Non-sprouted seeds, indicated by a plant growing medium void of a sprout, may be discarded. The germination sub-system may also be able to be modified slightly to produce microgreens.

The control system may also operate a transplanting subsystem 208 that includes a transplanting robot configured to distribute healthy sprouts from germination subsystem 206 to any of multiple (e.g., six) plant support structures (e.g., plant growth carousels). For example, such a structure may include idler sprockets 210 tied into the greenhouse frame, and a plant suspension and drive subsystem, which suspends and circulates plants through upper and lower portions 202 and 204 of the greenhouse enclosure to control amounts of light to which the plants are exposed. In some implementations, the plant suspension and drive subsystem circulates plants that are contained in plant beds 212. Directions of general motion of the circulated plant beds are indicated by arrows 214.

The plant suspension and drive subsystem may also be configured to transport plants from transplanting subsystem 208 and to a plant harvester subsystem 216. After plants are automatically harvested, they are transported to a post-harvest subsystem 218 where they are prepared and sorted. Roots may be removed, and the plants may be sorted into bins for distribution.

As mentioned above, in some embodiments, the plant suspension system may be tied into the frame of the greenhouse. This provides a benefit of allowing for relatively few structural components, thus reducing the cost of the greenhouse. In other words, the greenhouse structure and the plant suspension structure may be combined into one system. In addition, the robotic gantries may also be suspended by the greenhouse frame.

In some embodiments, the gantry robots may be located along the center of a vertical plant bed carousel allowing the gantry robots to tend to both sides of the plant bed. Also, the propagation conveyor may be located between a series of plant suspension systems so that a single gantry robot (e.g., for transplanting) can tend to every position in the farm. Also, having post processing sub-assemblies at the end of the plant suspension sub-assemblies allows for a single gantry to reach both sub-assemblies. These features provide benefits such as allowing the farm to be relatively cost-effective and to operate efficiently.

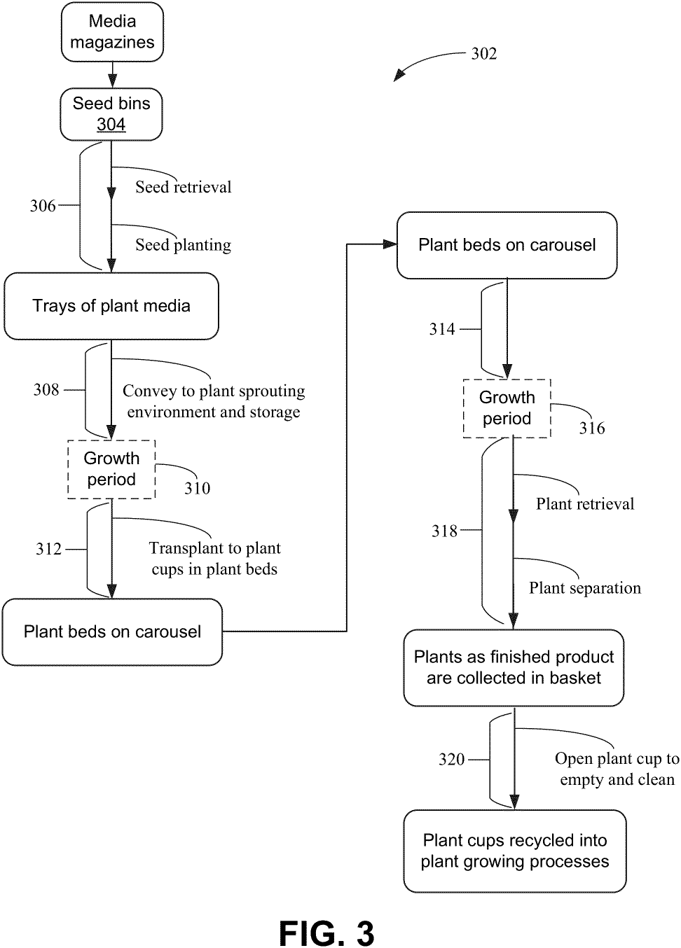

FIG. 3 is a flow diagram of a process 302 for planting, growing, and harvesting, according to some embodiments. One or more processing devices configured to implement control system 205 may perform process 302, which may include controlling greenhouse climate zones, water nutrient dosing, and robotics operations, just to name a few examples. For example, various portions of greenhouse enclosure 102 may have individualized environments (e.g., climate zones).

Germination subsystem 206, which includes growth media magazines and seed bins 304, may perform a first portion 306 of process 302. For example, the growth media magazines may be used to hold stacked trays of growth media that are lowered onto a conveyor when ready for seeding. The capacity of the growth media magazines is such that sufficient growth media is available while the greenhouse enclosure is operating autonomously over extended periods of time. Germination subsystem 206 may include a seeding station comprising robotics configured to automatically retrieve seeds from seed bins 304 and plant the seeds into growth medium carried by the growth media trays on a plant propagation conveyor. In some implementations, at the seeding station, a hollow needle connected to a vacuum may be used to pick up seeds individually and place them inside growth media. The seeding robotics may include the ability to adjust for varying seed diameters and shapes. In some examples, growth media may comprise a slow-release fertilizer, which can eliminate a need for a nutrient delivery system in the germination process.

During a portion 308 of process 302, the planted seeds may be watered while the plant propagation conveyor moves them to a holding area having an environment that is conducive for sprouting and growing the seeds during a growth period 310. For example, control system 205 may use germination subsystem 206 to control a sprout-growing environment (e.g., a propagation chamber) by adjusting levels of temperature, humidity, and intensity and duration of artificial lighting to maximize growth rate of the sprouts. In some examples, growth period 310 may be about ten days. In other examples, the growth period may be in the ranges of about five days to about ten days, about ten days to about fifteen days, about fifteen days to about twenty days, and other similar growth period ranges as selected based upon the type of plants being raised. A thin film of plastic or sheet metal, for example, may at least partially enclosed and separate this environment from other portions of greenhouse enclosure 102. Sprouts can be arranged in a relatively high-density collection of plants per area of space when compared to arrangements of plants in later portions of process 302. In some implementations, during growth period 310, germination subsystem 206 may inspect, via computer vision, the sprouts. Subsystem 206 may automatically discard sprouts that demonstrate poor development and may discard growth media having seed(s) that failed to sprout. Such discarding may include removing the sprout and closely-surrounding growth media from the tray.

In an alternative process, the seeding station may comprise robotics configured to automatically spread microgreens seeds on a surface of growth media carried by growth media trays on the plant propagation conveyor. In this process, the system produces microgreens instead of individual plants. The sprouted microgreens need not be transplanted and may be ready for harvesting (e.g., via automatic or hand cutting) and packaging in one or two weeks, for example.

In a portion 312 of process 302, subsequent to growth period 310, transplanting subsystem 208 may transplant healthy sprouts from the controlled environment of germination subsystem 206 to plant cups in plant beds 212, as described below. The plant beds may be supported and moved by the plant suspension and drive subsystem having a carousel-like configuration. Transplanting subsystem 208 includes a transplanting robot having an end effector configured to pick up individual sprouts in their growth medium (e.g., growth plugs) and transplant the sprouts into a plant cup supported by plant beds 212. Herein, the term “end effector” refers to the functioning end part(s) of a robotic arm. The transplanting robot allows for eliminating human labor for sprout transplanting. In some implementations, a single robotic assembly may be configured to reach every plant location in greenhouse enclosure 102. Sprouts may be moved while remaining within their growth medium to avoid root shock. Also, an end effector of the robotic system makes physical contact with the growth medium instead of the sprouts to avoid damage to the sprouts during transplanting.

In a portion 314 of process 302, plant cups supported by plant beds are provided a growth period 316 during which they can grow into mature plants. During growth period 316, the plants may receive both artificial and natural light while rotating in a carousel-like configuration of the plant suspension and drive subsystem.

In a portion 318 of process 302, mature plants are harvested by plant harvester subsystem 216 using a robotic harvester located adjacent to the plant suspension and drive subsystem. The plants may be removed from the plant cups and their roots may be removed in a plant separation process. With the roots removed, the plants may be a finished product ready to go to market. Post-harvest subsystem 218 may collect the finished product into a bin or basket for automatic or manual transportation. In a portion 320 of process 302, the robotic harvester of plant harvester subsystem 216 may open and clean the plant cup after the mature plant has been removed in the harvesting process. The plant cup may then be placed onto plant beds 212 to be recycled back into process 302.

In some embodiments, control system 205 may include a plant cup cleaning subsystem to perform the cleaning process of portion 320 of process 302. Post-harvest subsystem 218 may be capable of removing debris, scrubbing, and sanitizing the just-used plant cups, readying them for next use in the cycle. The debris, which may otherwise be considered waste, may be collected for composting. The plant cup cleaning subsystem may be configured to clean any roots intertwined with the plant cup to ensure it is reusable in the next plant growth cycle. The plant cup cleaning subsystem may include a root disposal bin, located below one or more cleaning brushes, to collect roots and growth media. A comb may be combined with the cleaning brushes to clean the brushes themselves of roots. After the plant is removed from the plant cup, the plant cup may be ready for root and growth media removal. Once the plant cup, held by plant harvester subsystem 216, is above the brushes and disposal bin, the plant cup is opened to release any large debris (e.g., roots and growth media) from within the plant cup. At this point the brushes may turn on and rotate opposite to each other. Plant harvester subsystem 216 may then lower the open plant cup so that the brushes come into contact with the inside of the two cup halves, thus removing any smaller debris. Additional processes might include the use of a chemical solution to further clean and/or sanitize the plant cups. Once this process is completed the cup may be closed and returned to its original position or another position in the plant suspension and drive subsystem.

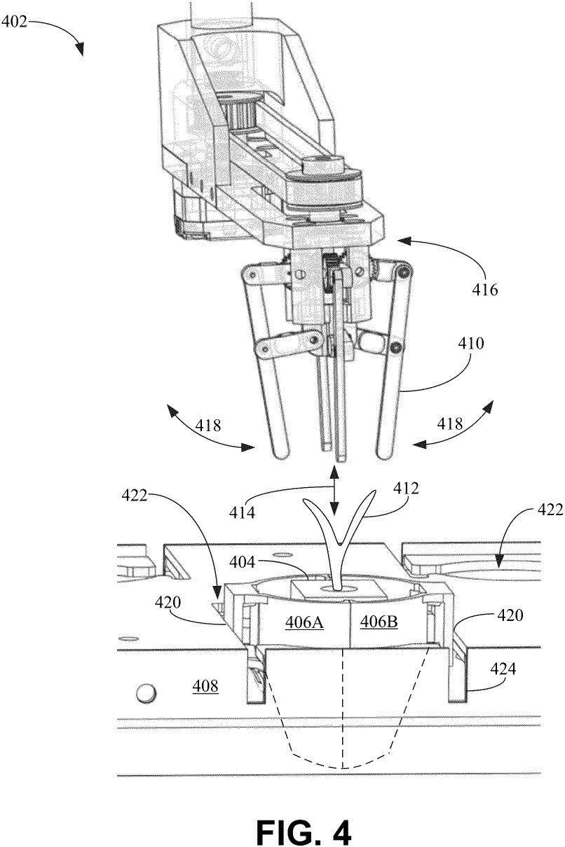

FIG. 4 is a perspective view of a transplanting end effector 402 of a transplanting robot of transplanting subsystem 208 engaging with growth media 404 in a plant cup 406 (including plant cup halves 406A and 406B) that is seated in a plant bed 408, according to some embodiments. Plant bed 408 may be the same as or similar to plant bed 212. End effector 402 includes fingers 410 configured to pick up individual sprouts 412 by their growth medium 404 from the sprout-growing environment (e.g., a propagation conveyor) of germination subsystem 206. End effector 402 then transplants the sprouts, in their growth media, into plant cup 406 supported by plant bed 408. FIG. 4 illustrates the end result of sprout 412 transplanted into plant cup 406 by end effector 402 that substantially followed a motion indicated by arrow 414. In other words, the end effector, once aligned over a target plant cup, proceeds in a downward vertical direction (the down arrow of 414) to drop off sprout 412 into the plant cup. The end effector then proceeds in an upward vertical direction (the up arrow of 414), retracting away from the deposited sprout, to retrieve another sprout from germination subsystem 206.

The transplanting end effector may be designed to grab growth media with minimal contact with any part of sprout 412. In other words, to avoid damage to the young plant, fingers 410 of end effector 402 are configured to not contact sprout 412 or roots inside the growth medium. In some implementations, a single timing belt-driven worm gear coupled with four worm wheels 416 may create a symmetric finger motion 418 that closes or opens the fingers to grab the growth medium or release the growth medium, respectively. Though four fingers 410 are illustrated in the example, of FIG. 4, other implementations may have a different number of fingers (e.g., two) and different shaped fingers (e.g., pointed, needle-like). Claimed subject matter is not limited in this respect.

In various embodiments, plant cup 406 is a “split cup” including two halves, 406A and 406B. The two halves are held together by plant bed 408. More specifically, edges 420 of openings 422 in plant bed 408 maintain the two halves together in a closed configuration, as illustrated in FIG. 4. Plant bed openings 422 may also be “D”-shaped (in a top view), for example, to prevent the possibility of plant cup rotation with respect to the plant bed. Plant bed 408 includes a plurality of openings 422 to accommodate relatively many plant cups, as described below. In some implementations, plant bed 408 includes notches 424 configured to receive an end effector of plant harvester subsystem 216, which is described in detail below, for lifting plant cup 406 out of opening 422. As illustrated in FIG. 4, notches 424 are located along the outward facing sides of plant bed 408. This location allows for harvesting at root level via the plant cup and thus avoids damage to plant leaves during harvesting. For example, when end effector fingers enter plant cup side openings (e.g., 902, introduced below) via the notches during plant harvesting, plant leaves and the end effector fingers are separated apart by a substantial distance.

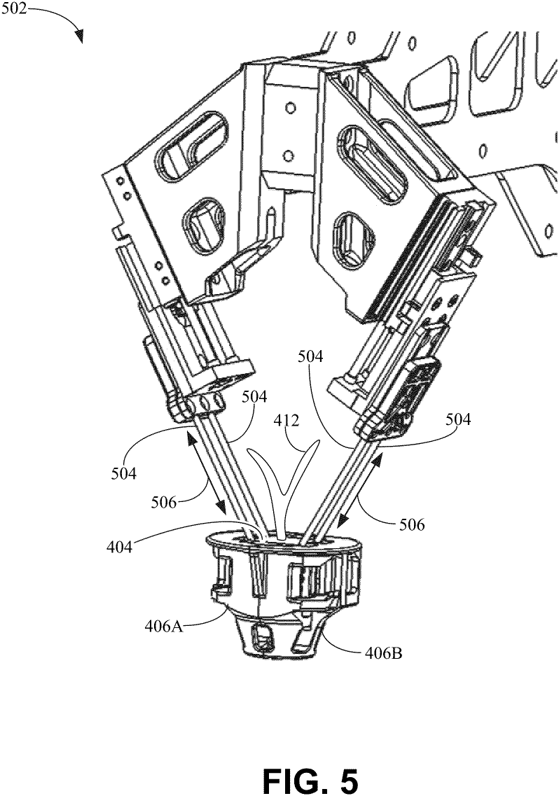

FIG. 5 is a perspective view of a transplanting end effector 502 engaging with growth media 404 in plant cup 406 (including plant cup halves 406A and 406B, as described above), according to other embodiments. End effector 502 includes needles 504 (four are illustrated by way of example only) configured to pick up individual sprouts 412 by their growth medium 404 from the sprout-growing environment (e.g., a propagation chamber) of germination subsystem 206. End effector 502 then transplants the sprouts, in their growth media, into plant cup 406 supported by plant bed 408. End effector 502 is similar to end effector 402 except that needles 504 “replace” fingers 410. Also, the motion of engagement with growth media 404 by needles 504 is different from that of fingers 410. For example, needles 504 engage with growth media 404 by a plunging action, indicated by arrows 506. In other words, needles 504 enter or leave the growth medium in a direction along the axis of the needles such that there is no rotation of the needles. In contrast, in some implementations, fingers 410 of end effector 402 may have a rotating component of motion.

FIG. 5 illustrates an interaction between end effector 502 and growth media in a plant cup without illustrating a plant bed (e.g., 408), for sake of illustrative clarity. The two halves of plant cup 406, however, would not remain together without the retaining properties of a plant bed.

The transplanting end effector may be designed to grab growth media without contacting any part of sprout 412. In other words, to avoid damage to the young plant, needles 504 of end effector 502 are configured to not contact sprout 412 or roots inside the growth medium. Though four needles 504 are illustrated in the example, of FIG. 5, other implementations may have a different number of needles (e.g., two or three) and different shaped needles. Claimed subject matter is not limited in this respect.

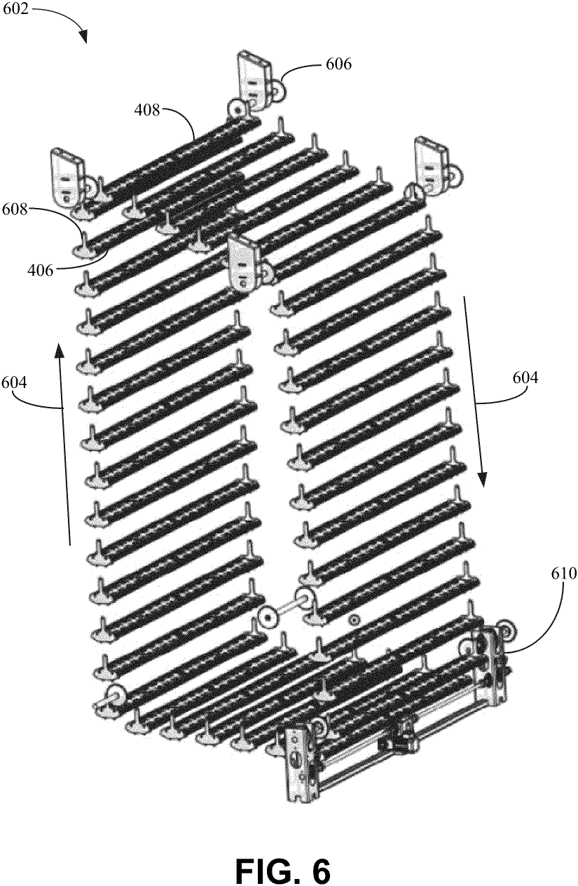

FIG. 6 is a perspective view of a plant bed carousel system 602, which is part of the plant suspension and drive subsystem, according to some embodiments. Plant bed carousel system 602 supports and transports a plurality of plant beds 408 that contain plants during their main growth stage. In a particular embodiment, greenhouse enclosure 102 may include six plant bed carousel systems 602 arranged in two rows of three, wherein the plant bed carousel systems of one row are arranged in a mirrored configuration with those of the other row. Arrows 604 indicate the carousel-like motion of the plurality of plant beds 408.

Plant bed carousel system 602 is configured to circulate plant beds 408 through upper portions 202 and lower portions 204 of greenhouse enclosure 102 so that plants in plant cups 406 in the plant beds can receive natural light in the upper portions and artificial light in the lower portions. The carousel motion also allows the plants to receive circulated air. Plant bed carousel system 602 may also be configured to move plants into position for mechanical harvesting and transplanting, as described below.

In some implementations, plant bed carousel system 602 may include mechanical infrastructure to allow the plant bed carousel to act similar to a water-wheel, which utilizes the uneven distribution of water to rotate the water-wheel. For instance, the plant bed carousel may rotate in such a fashion by filling top plant beds with water (e.g., during the initial portion of the downward part of the rotation cycle) and draining the plant beds of water at a lower level (e.g., during or immediately prior to the upward part of the rotation cycle). This process may supplement the action of electrical motors for the rotation of the plant bed carousel system, thus reducing energy usage, for example.

In some embodiments, driven sprockets 606 may be connected to the framework of plant suspension systems 104 and drive systems 106 and suspend plant beds 408 that are supported by chains (not illustrated) via suspension brackets 608. The chains, rotated by a drive system assembly 610, suspend plant beds 408 in the configuration illustrated in FIG. 6. Using a chain and drive sprockets, instead of a belt and pulley, for example, may allow the plant beds to maintain alignment throughout their rotation. Links on the chain may allow the plant beds to be positioned at heights that are optimal for the type of plants growing within the respective bed.

In some embodiments, plant bed carousel system 602 includes a plant bed locating system (not illustrated) to ensure that the plant beds may consistently be placed at the same height and same plane for harvesting and transplanting. For example, the plant bed locating system may include a proximity sensor to detect when a plant bed has arrived at the harvesting location and if there is any rocking or other unwanted motion of the plant beds. The sensor may also trigger a fault if a plant bed moves in an undesirable manner. Such motion sensing may be important because the plant beds should be steady when they interact with end effectors, for example.

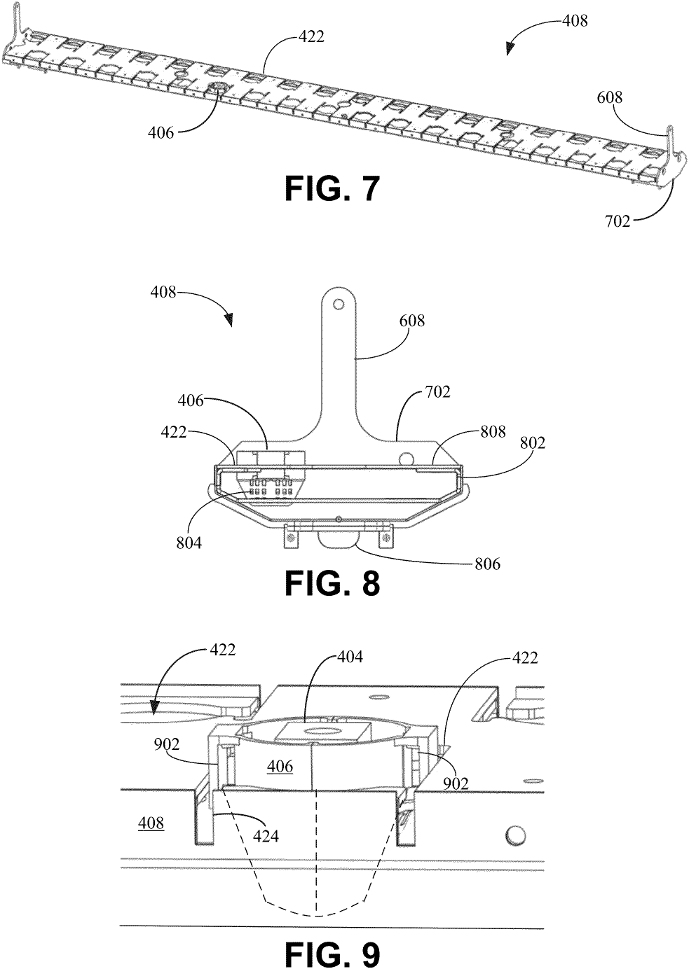

FIG. 7 is a perspective view of plant bed 408, according to some embodiments. Plant bed 408 includes a plurality of openings 422 configured to hold plant cups 406. In the implementation illustrated, the plant cups are staggered along the length of the plant bed to allow for increased density of plants on a single plant bed. In some implementations, each of plant cups 406, plant beds 408, and/or each of the openings 422 may be coded to have an identification that allows the control system (e.g., 205) of the greenhouse to track the type of plant, its location, and its stage of growth in each plant cup at any time. For example, the identification codes can include quick response (QR) codes, bar codes, alphanumerical codes, and other similar identification codes. In some particular implementations, control system 205 may be configured to track the flow of individual plants through the entire system in process 302 (e.g., from seed to harvest). The control system, when performing an action, may automatically save data or metadata associated with the action. For example, a graphical user interface (GUI) for control system 205 may allow a user to specify the type of seed in each seed bin, number of seeds per growth media (e.g., per plant cup), and number of plants desired per plant bed or growth media tray. Software may track which seed is planted in each plant cup, may record plant bed and plant cup identification during transplanting, and record a harvest bin number. This allows for propagation durations, harvest dates, and other aspects of plant growth to be recorded automatically.

As illustrated in FIG. 6, plant beds 408 may be placed onto plant bed carousel system 602 via suspension brackets 608, which may be attached to an end cap 702. This modular design allows for positioning of the plant beds on system 602 to be easily reconfigured for plant height adjustment and space optimization. For example, the plant beds may be manually reconfigured for vertical plant spacing adjustments. Additionally, the plant beds may also be manually reconfigured for horizontal plant spacing adjustments by utilizing less than all openings 422 (e.g., placing plant cups 406 in every other one of the openings).

FIG. 8 is a cross-section view of plant bed 408, according to some embodiments. In addition to elements described above, plant bed 408 includes a waterproof hull 802 configured to hold nutrient-rich water and to act as an outer shell of the plant bed. Roots of plants in plant cups 406 protrude through a number of small apertures 804 from the growth medium (e.g., 404) in the plant cups and into the nutrient-rich water. Over time, in the course of growing, the plants use and exhaust the nutrients in the nutrient-rich water. Thus, control system 205 may at least partially drain (e.g., by gravity or by mechanical suction), periodically or from time to time (e.g., once or twice per day), the nutrient-depleted water contained by hull 802. Fresh nutrient-filled water is added to replace the drained water. In some implementations, control system 205 may actuate or otherwise operate a spring-loaded flush valve 806 to drain the nutrient-depleted water, which may be captured for reprocessing and reused in the watering system. In some examples, control system 205 may use sensors to measure water flow, electrical conductivity, dissolved oxygen, pH, and temperature, all of which may be recorded for later analysis or used by, for example, the control system to make real-time decisions. The control system may measure drained water for nutrient concentrations and use the measurements in feedback loops to adjust nutrient levels as needed to achieve ideal nutrient recipes.

Control system 205 may provide water to the plant beds in parallel, as opposed to in series. This is in contrast to typical irrigation systems that use a series of manifolds and mainlines to deliver water from a single source, making it difficult to deliver varying water-nutrient recipes to specifics crops in the system. However, as described herein, control system 205 may individually fill and drain the plant beds. This allows for mixing specific nutrient recipes for plant beds based on what is growing in the plant beds and can be customized to specific plant types.

Plant bed 408 may include a top cover 808 that acts as a “ground level” of the plant bed. Top cover 808 includes openings 422 configured to receive plant cups 406.

FIG. 9 is a perspective view of plant cup 406 seated in plant bed 408, according to some embodiments. As mentioned above, plant bed 408 includes notches 424 configured to receive an end effector (e.g., end effector 402 and/or end effector 502 as described above) of plant harvester subsystem 216 for lifting plant cup 406 out of opening 422. Plant cups 406 include side openings 902 that positionally correspond to notches 424. For example, notches 424 allow a robotic harvester’s fingers (e.g., end effector) to be inserted into side openings 902 (e.g., receiver portions) below the plant foliage (e.g., below top cover 808, acting as ground level of the plant bed) during plant retrieval. In other words, notches 424 and side openings 902 on the sides of plant cups 406 enable plants in the plant cups to be harvested below leaf-level of the plants so that damage during harvesting by end effector contact with the plant or its leaves does not occur. This configuration allows plants to be harvested automatically with relative ease, regardless of the density of foliage. When a plant is ready for harvesting, the plant cup is grabbed, via side openings 902, by a robotic end effector and brought to a post-harvest/storage area.

As mentioned above, each plant cup 406 is at least partially filled with growth media 404, which may be artificial media such as Flexi Plugs®, though other hydroponic “sponge” media such a Rockwool®, Oasis Cubes®, or others may be used, and claimed subject matter is not so limited. Growth media 404 provide aeration, water holding capacity, and consistency. Growth media 404 may be an off-the-shelf product that enables slow-release of fertilizer, improved control over production processes, less mess, increased uniformity, and the ability to stay intact while being held by transplanting automation. Growth media 404 may comprise a “sponge like” material that can compress when being held within plant cup 406.

In some embodiments, bottom portions of the plant cup may include small apertures 804 in place of a “mesh” like structure or similar fine openings (e.g., screen-like). This is to help prevent plant roots from becoming intertwined into these fine openings, making the plant cup difficult to clean. In still other embodiments, top portions of the plant cup may include tabs to help ensures that growth media stays within the plant cup after transplanting mechanisms release from the growth media. In other words, such tabs ensure the growth media remains within the plant cup until it is opened.

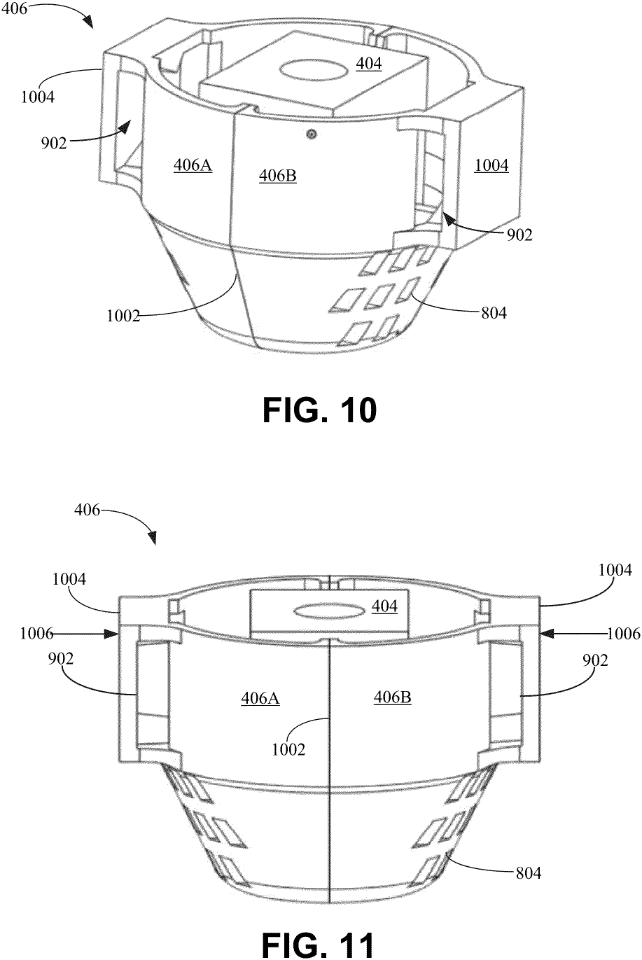

FIG. 10 is a perspective view of plant cup 406 and FIG. 11 is a top-front view of the plant cup, according to some embodiments. Plant cup 406 is a “split cup” comprising two halves, 406A and 406B. The two halves, which are engaged with each other at edges 1002, which form a seam, may be held together in a closed configuration by two different ways in process 302. In one way, the two halves are held together by plant bed 408. More specifically, in one implementation, edges 420 (illustrated in FIG. 4) of openings 422 constrain surfaces 1004 of the plant cups so that edges 1002 of plant cup halves 406A and 406B are held together by a reaction force that may arise from edges 420. When a plant cup 406 is “dropped” or inserted into an opening 422, edges 420 of the opening may impart a restraining force 1006 on surfaces 1004. In another implementation, each of the plant cup halves 406A and 406B may rest, by gravity, on a portion of plant bed 408. The limiting size of opening 422 may keep the two halves together and in contact at edges 1002.

Another way the two plant cup halves are held together is by an end effector, such as during portion 318 of process 302, when mature plants are harvested by plant harvester subsystem 216 using end effectors of a robotic harvester. For example, each of a pair of end effector fingers, as described in further detail below, may respectively hold the two plant cup halves via side openings 902. Accordingly, the relative separation of the two fingers may determine if the two plant cup halves are together or separated.

The split plant cup design of 406 provides a number of benefits. For example, the design allows for non-plant-contact manipulation during process 302 and relatively easy automatic removal of used growth media, roots, and other debris. For example, plant growth media may be liberated for release via gravity from the two separable cup portions when the two separable cup portions are separated at the seam by the end effector, as described below. In some implementations, another benefit is that the split plant cup may be configured to hold onto sprouts during transplanting.

In some embodiments, each of plant cup halves 406A and 406B are mirrored parts of each other and need not include snap-together or other interlocking features. In other words, the two halves may merely be held together by virtue of their relative adjacent positioning. In other embodiments, each of plant cup halves 406A and 406B may include male and corresponding female parts to engage with each other to aid in mutual alignment. In still other embodiments, each of plant cup halves 406A and 406B may include magnets having their poles mutually compatible for attraction to aid in holding together the two plant cup halves.

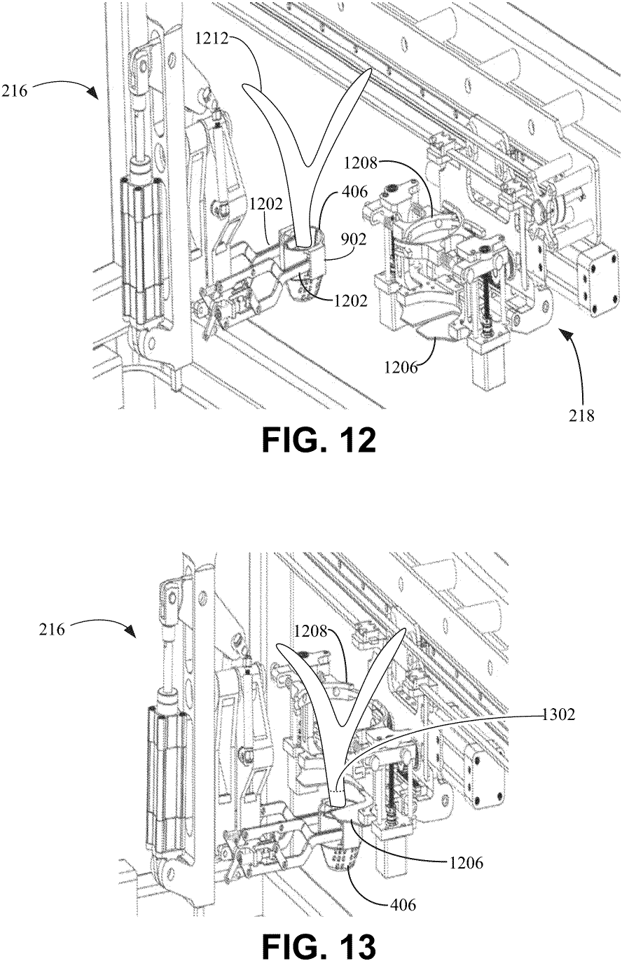

FIG. 12 is a perspective view of end effector fingers 1202 of plant harvester subsystem 216 engaged with a closed plant cup 406 approaching post-harvest subsystem 218, according to some embodiments. Similarly, FIG. 13 is a perspective view of a plant in the plant cup engaged with the post-harvest subsystem, according to some embodiments. Post-harvest subsystem 218 may be configured to remove plant roots, sort, and store plants. For example, post-harvest subsystem 218 includes a cutting mechanism 1206 (e.g., blades) for removing roots from plants and plant brackets 1208 for supporting the plants during root cutting.

Plant harvester subsystem 216 is configured to hold a mature plant 1212, via plant cup 406, that is ready for harvest. Plant harvester subsystem 216 includes end effector fingers 1202 that hold and transport plant cup 406 by engaging with side openings 902. Plant harvester subsystem 216 transports plant cup 406 to post-harvest subsystem 218, which has cutting mechanism 1206 and plant brackets 1208 both in their open positions. Plant harvester subsystem 216 places plant 1212 in post-harvest subsystem 218 so that cutting mechanism 1206 is in a relative position with the plant to cut roots, such as at cutting line 1302, which may be modified to adjust the cutting height on the plant. An upper portion of plant 1212 is positioned in plant brackets 1208, which gently close on the plant and support the plant after root removal. Once this motion is completed, all the plant leaves may be corralled upward with the base of the plant exposed for clear cutting. Cutting mechanism 1206 closes to cut off roots from plant 1212. In an alternative case, not illustrated, a circular rotating blade may engage with the roots in the cutting process. End effector fingers 1202 of plant harvester subsystem 216 are now holding onto plant cup 406, which contains only roots and growth medium. In other words, the cut roots remain in the plant cup for disposal. The leafy plant portion is held by plant brackets 1208. In some implementations, dual stepper motors may lift plant brackets 1208 upward, ensuring that the roots are completely detached from the plant. At the same time, plant harvester subsystem 216 (and plant cup) moves downward. At this point the plant is completely separated from the plant cup and its roots.

Plant harvester subsystem 216 subsequently removes plant cup 406 from post-harvest subsystem 218, leaving the leafy plant portion behind. Post-harvest subsystem 218 may then open cutting mechanism 1206 and plant brackets 1208 so as to drop the leafy plant portion into a collecting basket below for harvest. In some implementations, the harvested plant may be inspected by a machine vision system for final individual unit testing for approval or rejection to ensure product quality and consistency. Thus, there may be more than one collecting basket. In some implementations, the collection area may contain misters, refrigeration, and/or other devices to reduce perishability of harvested plants. Meanwhile, as described below, plant harvester subsystem 216 operates end effector fingers 1202 to split apart plant cup 406 so that roots and growth media may be removed.

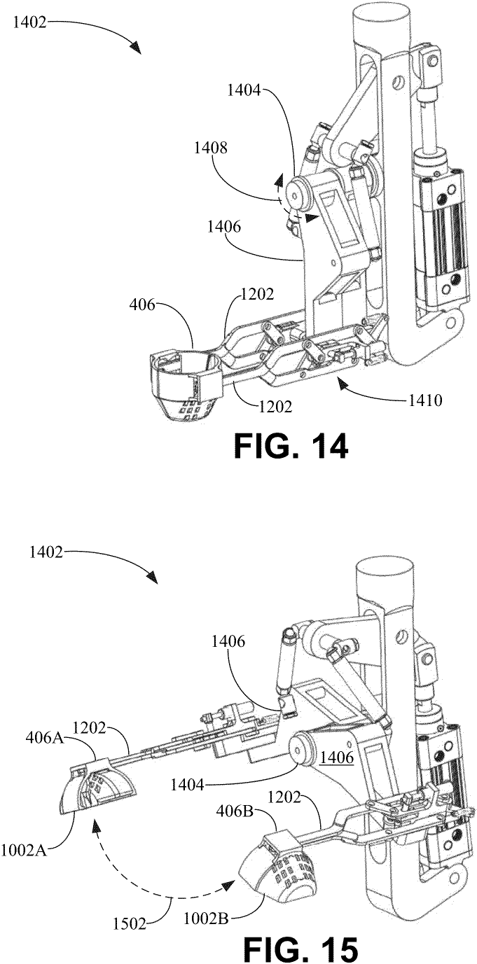

FIG. 14 is a perspective view of an end effector 1402 that includes end effector fingers 1202 of plant harvester subsystem 216 in a “closed” position and engaged with a closed plant cup, according to some embodiments. End effector 1402 also includes an axial portion 1404 on which are attached arms 1406 that are respectively connected to end effector fingers 1202. Axial portion 1404 is configured to rotate arms 1406 as indicated by arrow 1408. In some implementations, end effector 1402 further includes an extender portion 1410 configured to extend or retract distal ends of end effector fingers 1202.

Axial portion 1404 may be configured to place end effector fingers 1202 in a first separation state or a second separation state, wherein the first separation state (e.g., a closed position) corresponds to each part of the splitable plant cup being joined together and the second separation state (e.g., an open position) corresponds to each part of the splitable plant cup being separated from each other.

When in the closed position, plant harvester subsystem 216 is able to retrieve plant cups from plant beds (e.g., 408) and move them to various locations in greenhouse enclosure 102. Before plant harvester subsystem 216 can move a plant cup, end effector fingers 1202 must engage with side openings 902 of the plant cup so that the plant cup is held securely. In the closed position, plant cups can both be taken from and returned to the plant beds, as well as taken to post-harvest subsystem 218, for example.

FIG. 15 is a perspective view of end effector fingers 1202 in the second separation state, engaged with an opened plant cup, according to some embodiments. As described above, plant harvester subsystem 216 transports a plant to be harvested, which is in plant cup 406, to post-harvest subsystem 218, which cuts the roots away from the plant. After the cutting process, plant harvester subsystem 216 pulls the plant cup, which is closed and includes roots and growth medium, away from post-harvest subsystem 218. As illustrated in FIG. 15, end effector fingers 1202 separate from each other, as indicated by arrow 1502, to split open plant cup 406 into its two halves, 406A and 406B at edges 1002A and 1002B, respectively. This opening action, controlled by axial portion 1404, for example, may release the roots and growth media, which fall into a bin, for example. Side openings 902 of the plant cup may be shaped with respect to each of the end effector fingers to prevent substantial rotation with respect to the end effector fingers (e.g., spinning) of each of the two separable cup portions. In other words, the side openings should be shaped so that the plant cup halves may be securely held by the end effector fingers. Such shapes may be rectangular, for example. Circular shapes may allow for rotation with respect to the end effector fingers and thus are preferable avoided. Because axial portion 1404 separates end effector fingers 1202, and thus the plant cup halves, in a rotating fashion, as the plant cup halves move apart, their orientation becomes more inverted so as to “dump” their contents via gravity. The splitting ability of the plant cup thus provides a benefit wherein the plant cup may be emptied and cleaned more simply compared to the case where a plant cup remains whole. After being split, emptied, and cleaned, plant cup 406 may be ready to be recycled into process 302 where, for example, the transplanting robot of transplanting subsystem 208 may place a new sprout in the newly cleaned plant cup. Cleaning may include a process of brushing and/or dipping in a cleaning/sanitizing solution, for example.

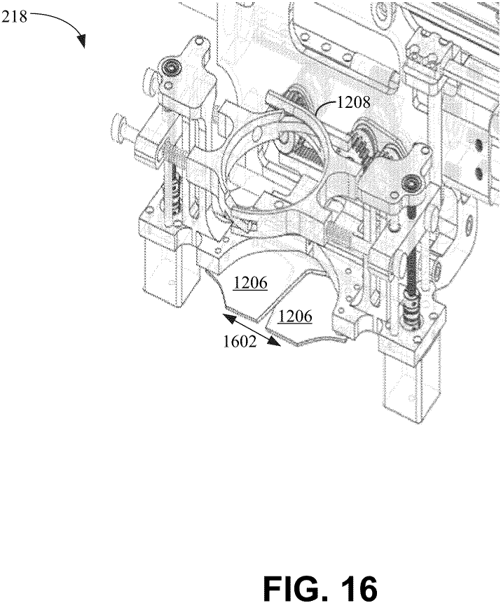

FIG. 16 is a perspective view of cutting mechanism 1206 and plant brackets 1208 of post-harvest subsystem 218, according to some embodiments. Motion of blades of cutting mechanism 1206 is indicated by arrow 1602. In some implementations, plant brackets 1208 may be spring loaded to allow the brackets to accommodate varying crop characteristics (for example, differing plant shapes and sizes such as head lettuce or basil) by adjusting the gripping diameter. The continuous interlocking brackets may ensure that plant leaves are corralled upward. The spring also allows the (pair of) brackets to become static while cutting mechanism 1206 continues to pass forward in a horizontal movement (e.g., arrow 1602). Thus, both plant holding and cutting may take place in one movement. The interlocking design of plant brackets 1208 may ensure that no leaves are dangling downward when the cutting process takes place. In some implementations, two stepper motors move the plant brackets vertically, depending upon the plant geometry. This up and down movement may also pull the plant up when the blades are engaged to ensure roots are completely detached.

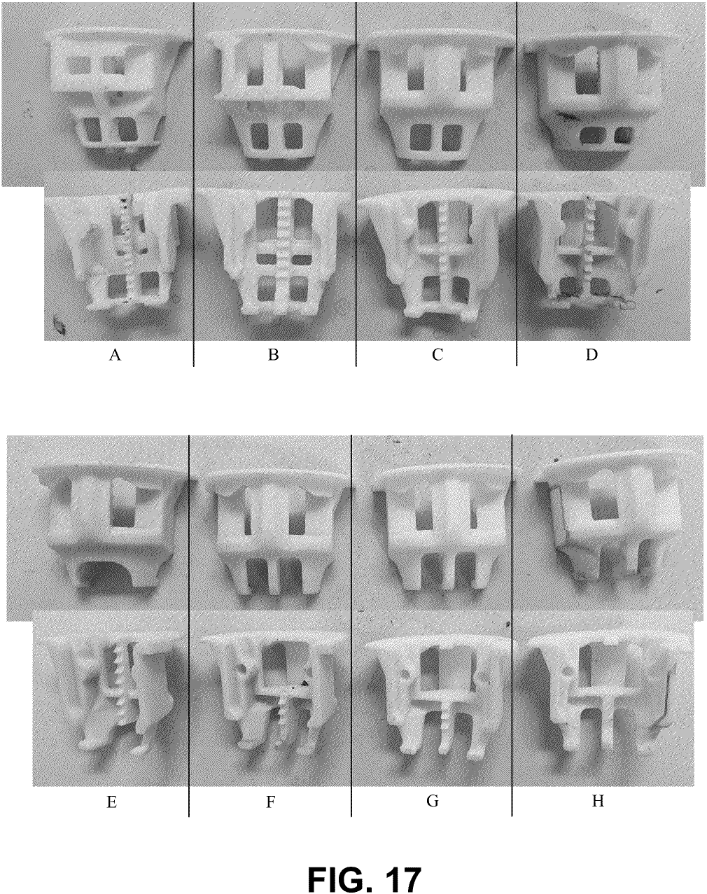

FIG. 17 includes a series of photographs of plant cups having various features, according to some embodiments. In each lettered column (A-H) the top photo shows an external view of the plant cup and the bottom photo shows an internal view.

In column A, the split plant cup design includes holding features on the external face of the cup. Barbs on the internal central face may be useful for holding growth media in place during transplanting. In column B, some of the holding feature sizes are increased for easier end effector insertion. In column C, the cup has a rounded external face for easier insertion into the plant bed, helping to prevent the cup from getting caught on an edge while being returned to the plant beds. In column D, the plant cup is shortened to save material and to remain compatible (e.g., regarding geometries) with the plant bed. In column E, lower cutouts of the cup are removed to prevent plant roots from becoming entangled, which can lead to difficult cleaning. In column F, a central finger is added to lower the internal face of the plant cup. This helps to prevent growth media from getting pulled through the bottom of the plant cup when being harvested from the plant bed. Also, upper central barbs are removed from the internal face of the cup to allow for improved injection moldability. In column G, a tab is added to the upper center internal face. This addition is to help prevent growth media from pulling out of the plant cup during transplanting. Also, the tab helps to ensure that the growth media remains in the plant cup until it is opened. In column H, the lower barb is removed from the internal face of the cup. As plant roots grow larger, the growth media may expand and press against the barbs. This may tend to open the plant cup within the plant bed, making it difficult to extract the plant cup from the bed. Removing the lower barb helps to avoid this problem.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A system for manipulating plant growth media, the system comprising:
an end effector that includes a first finger and a second finger; and
a plant cup that includes a first opening to receive the first finger and a second opening to receive the second finger, wherein the plant cup is configured to i) split open to release the plant growth media or ii) be held closed to retain the plant growth media, the opening and closing based on positions of the first finger with respect to the second finger.

2. The system of claim 1, wherein the plant cup comprise two separable cup portions configured to i) at least partially retain the plant growth media when the two separable cup portions are joined at a seam that is mutual to the two separable cup portions, and ii) release the plant growth media from the two separable cup portions when the two separable cup portions are separated at the seam.

3. The system claim 2, wherein the two separable cup portions are configured to be respectively held and moved, independently of each other, via the first and second openings by the first and second fingers of the end effector.

4. The system of claim 2, wherein the plant cup includes apertures on each of the two separable cup portions to allow plant roots to traverse from the plant growth media to outside the plant cup.

5. The system of claim 2, wherein the two separable cup portions are further configured to, when joined at the seam, fit into a plant tray that applies static retention forces on the two separable cup portions to keep the two separable cup portions joined together.

6. The system of claim 2, wherein the end effector further includes an axial portion configured to place the first and second fingers in a first separation state or a second separation state, wherein the first separation state corresponds to the two separable cup portions being joined together and the second separation state corresponds to the two separable cup portions being separated from each other.

7. The system of claim 6, further comprising:
a first extender portion between the first finger and the axial portion, wherein the first extender portion is configured to extend or retract a distal end of the first finger; and
a second extender portion between the second finger and the axial portion, wherein the second extender portion is configured to extend or retract a distal end of the second finger.

8. The system of claim 7, wherein extending the first and second fingers engages the first and second fingers with the two separable cup portions and retracting the first and second fingers separates the first and second fingers from the two separable cup portions.

9. The system of claim 6, wherein the axial portion is configured to place the first and second fingers in the first or second separation states by rotation about a central axis, and wherein the first and second fingers are substantially parallel with the central axis.

10. The system of claim 1, wherein as a distance between the first and second fingers increases, inversion of each part of the splitable plant cup increases so as to allow contents of each part of the splitable plant cup to fall away from each part of the splitable plant cup via gravity.

11. A plant cup for containing plant growth media, the plant cup comprising:
two separable cup portions configured to i) at least partially retain the plant growth media when the two separable cup portions are joined at a seam that is mutual to the two separable cup portions, and ii) liberate the plant growth media for release from the two separable cup portions when the two separable cup portions are separated at the seam.

12. The plant cup of claim 11, further comprising:
a receiver portion on each of the two separable cup portions to temporarily receive a finger of an end effector, wherein the two separable cup portions are configured to be held and moved, independently of each other, via the receiver portions by the fingers of the end effector.

13. The plant cup of claim 12, wherein the receiver portion on each of the two separable cup portions is shaped with respect to the finger of the end effector to prevent substantial rotation of each of the two separable cup portions.

14. The plant cup of claim 11, further comprising:
apertures on each of the two separable cup portions to allow plant roots to traverse from the plant growth media to outside the plant cup.

15. The plant cup of claim 11, wherein the two separable cup portions are further configured to, when joined at the seam, fit into a plant tray that applies static retention forces on the two separable cup portions to keep the two separable cup portions joined together.

16. A robotic end effector to manipulate each part of a splitable plant cup, the robotic end effector comprising:
a first finger and a second finger that are each configured to engage respectively with each part of a splitable plant cup; and
an axial portion configured to place the first and second fingers in a first separation state or a second separation state, wherein the first separation state corresponds to each part of the splitable plant cup being joined together and the second separation state corresponds to each part of the splitable plant cup being separated from each other.

17. The robotic end effector of claim 16, further comprising:
a first extender portion between the first finger and the axial portion, wherein the first extender portion is configured to extend or retract a distal end of the first finger; and
a second extender portion between the second finger and the axial portion, wherein the second extender portion is configured to extend or retract a distal end of the second finger.

18. The robotic end effector of claim 17, wherein extending the first and second fingers engages the first and second fingers with the splitable plant cup and retracting the first and second fingers separates the first and second fingers from the splitable plant cup.

19. The robotic end effector of claim 16, wherein the axial portion is configured to place the first and second fingers in the first or second separation states by rotation about a central axis, and wherein the first and second fingers are substantially parallel with the central axis.

20. The robotic end effector of claim 16, wherein as a distance between the first and second fingers increases, inversion of each part of the splitable plant cup increases so as to allow contents of each part of the splitable plant cup to fall away from each part of the splitable plant cup via gravity.
